(19) United States
(12) Patent Application Publication
(10) Pub. No.: US 2007/0139188 A1
(43) Pub. Date: Jun. 21, 2007

(54) Method and apparatus for communicating between a home network and a wireless network

(75) Inventors: Jeffrey D. Ollis, Dresher, PA (US); John M. Coogan, Lansdale, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/300,933

(22) Filed: Dec. 15, 2005

(51) Int. Cl. G08B 1/08

(52) U.S. Cl. 340/539.12; 340/825.36

(57) ABSTRACT

A bridge apparatus is provided that interfaces the home network to the wireless network. The bridge apparatus is separate from the security panel module, and includes a processor that translates commands received from the home network control unit into wireless network commands and transmits the wireless network commands over a wireless network to a security monitoring service center or to a health monitoring service center, depending on whether the commands relate to detected security conditions or detected health conditions.

### TECHNICAL FIELD OF THE INVENTION

The invention relates to home networks and, more particularly, to a bridge apparatus that interfaces a home network to a wireless network.

### BACKGROUND OF THE INVENTION

Home networks enable devices and systems within the home to be interconnected with each other and to communicate with each other over the network. Standard and proprietary protocols exist that govern communications between the networked devices and systems. Examples of such protocols include the Zigbee, Z-Wave and AFM-II protocols. Typical home networks include a server that is connected to a home security system, which, in turn, is connected to various detectors within the home for detecting certain conditions such as, for example, open windows and doors. The home security system typically includes an alarm system that is activated when one or more conditions are detected.

Home security systems are typically connected to the telephone circuit wiring within the home so that detection of one or more conditions can be communicated via the Public Switched Telephone Network (PSTN) to a security system monitoring service center. The home security system includes a panel module that functions as the control center for the security system. The panel module is connected to the various detectors and to the telephone circuit wiring. The panel module translates detected conditions into commands that cause an audio warning device to be activated and a telephone call to be placed to the security system monitoring service center.

Many home security system panels include a wireless communications module that enables a call to be placed over the wireless network to the security system monitoring service center. The wireless communications module normally functions as a secondary mode of communications that is used when the PSTN connection is unavailable.

One of the disadvantages of including the wireless communications module in the panel module is that it requires the panel module to have additional functionality for interfacing with the wireless communications module even in cases in which the wireless link may never be used. For example, if the user does not have a subscriber account with a wireless service provider, the wireless link serves no purpose. In this case, the costs associated with including this additional functionality in the security panel is wasted.

### SUMMARY OF THE INVENTION

The invention provides a method and an apparatus for interfacing a home network to a wireless network. The apparatus comprises a home network interface component, a wireless network interface component, and a processor. The home network interface component is configured to receive a communication from a home network control center relating to at least one condition detected by at least one sensor within the home network. The processor is configured to receive one or more commands from the home network interface component and to translate the commands into wireless network commands. The wireless network interface component is configured to receive the translated commands from the processor and to place a call over a wireless network in accordance with the translated commands received from the processor.

The method comprises receiving a command in a home network interface component from a home network control center, processing the command in a processor that is in communication with the home network interface component to translate the command into a wireless network command, forwarding the wireless network command from the processor to a wireless network interface component, receiving the wireless network command in the wireless network interface component, and transmitting the wireless network command from the wireless network interface component to a wireless network.

The invention also provides a computer program for interfacing a home network to a wireless network. The program is embodied on a computer-readable medium and comprises instructions for receiving a command in a home network interface component from a home network control center, instructions for processing the command in a processor that is in communication with the home network interface component to translate the command into a wireless network command, instructions for forwarding the wireless network command from the processor to a wireless network interface component, instructions for receiving the wireless network command in the wireless network interface component, and instructions for transmitting the wireless network command from the wireless network interface component to a wireless network.

These and other features and advantages of the invention will become apparent from the following description, drawings and claims.

### BRIEF DESCRIPTION OF THE DRAWINGS

FIG. 1 illustrates a block diagram of the bridge apparatus of the invention in accordance with an exemplary embodiment.

FIG. 2 illustrates a pictorial diagram of a home network in which the bridge apparatus shown in FIG. 1 may be employed.

FIG. 3 illustrates a flow chart of the method of the invention in accordance with an exemplary embodiment performed by the bridge apparatus shown in FIG. 1.

### DETAILED DESCRIPTION OF THE PREFERRED EMBODIMENT

In accordance with the invention, a bridge apparatus is provided that interfaces the home network to the wireless network. The bridge apparatus is separate from the security panel module, and includes a processor that translates commands received from the home network control unit into wireless network commands and transmits the wireless network commands over a wireless network.

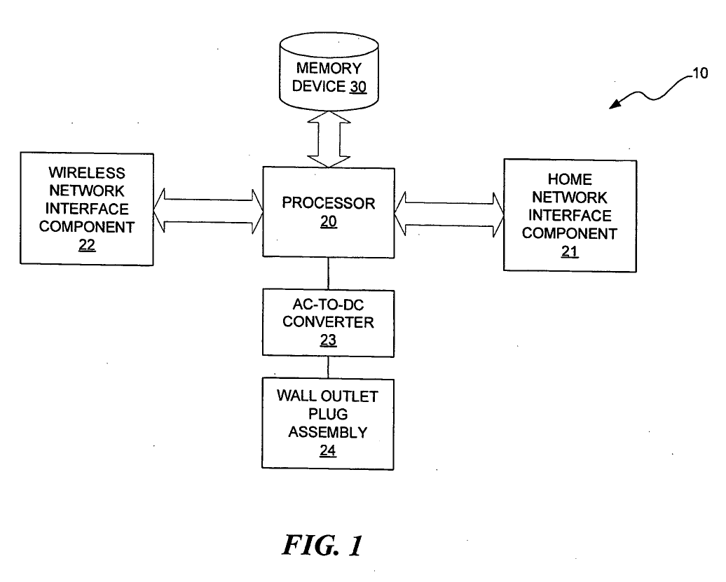

FIG. 1 illustrates a block diagram of the bridge apparatus 10 of the invention. The bridge apparatus includes a processor 20, a home network interface component 21, a wireless network interface component 22, an alternating current (AC)-to direct current (DC) converter 23 and a wall outlet plug assembly 24. In accordance with this embodiment, the bridge apparatus plugs into a normal wall outlet via plug assembly 23 to provide power to the bridge apparatus 20. The AC-to-DC converter 24 converts the AC signal into a DC signal, which is used as the power supply by the processor 20. The bridge apparatus 10 typically also includes a memory device 30 for storing software programs and data.

The home network interface component 21 provides the interface between the bridge apparatus 10 and a home network. The wireless network interface component 22 provides the interface between the bridge apparatus 10 and a wireless network. The processor 20 receives input from the home network interface component 21 and translates the input into wireless network commands, which are then output by the processor 20 to the wireless network interface component 22. The wireless network interface component 22 then transmits the commands wirelessly over the wireless network to a home security system monitoring service center. The home network interface component 21 and the home network server 50 may use a low-power wireless communications protocol to communicate with each other such as, for example, the Bluetooth protocol or the like.

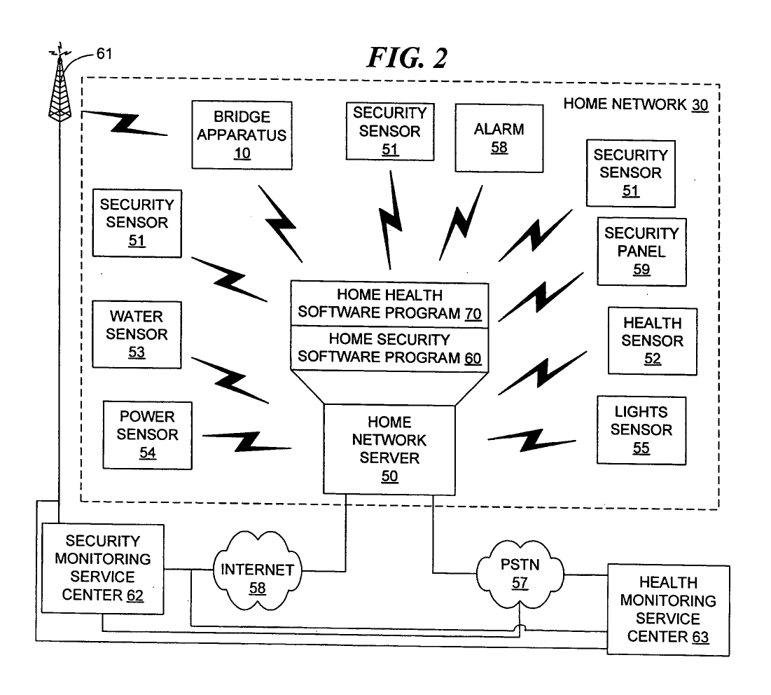

FIG. 2 illustrates a pictorial diagram of a home network in which the bridge apparatus 10 is employed. The home network 30 includes a home network control center, which is typically a server 50 programmed to run various application software programs. The server 50 has a wired or wireless connection to various sensors of the home network 30. For exemplary purposes, the server 50 is shown as having wireless links to the sensors. These wireless links may also use a low-power communications protocol such as, for example, the Bluetooth protocol or the like. The sensors typically include one or more security sensors 51, which may be, for example, sensors that detect when doors or windows are opened or closed, sensors that detect motion, etc. The sensors may also include health monitoring sensors 52 (e.g., biometric sensors) that detect a persons health conditions, e.g., heart rate, blood pressure, etc. The home network 30 may also include other sensors, such as a sensor 53 for monitoring water pressure, a sensor 54 for monitoring power to the home, and a sensor 55 for monitoring the home lighting system. A security panel module 59 is used to configure the security system and to allow a user to input information via a keypad of the panel module 59, such as for the purpose of arming and disarming the security system.

The server 50 of the home network 30 typically connects to the PSTN 57 and the Internet 58. The bridge apparatus 10 is configured to set up a wireless link between the bridge apparatus 10 and a wireless network, which is represented by the tower 61 in FIG. 2. The bridge apparatus 10 is also configured to set up a wireless link between the bridge apparatus 10 and the home network server 50. As stated above, the bridge apparatus 10 receives commands sent wirelessly from the server 50 and translates them into commands that are compatible with the standard for communications over the wireless network, such as code division multiple access (CDMA), time division multiple access (TDMA), Global System for Mobile Communications (GSM), General Packet Radio Services (GPRS), Short Messaging Service (SMS), 1G, 2G, 2.5G, 3G, 802.1X, etc.

The home network server 50 is capable of connecting to a home security monitoring service center 62 via wireless network 61, the Internet 58 and the PSTN 57. In addition, the home network server 50 is capable of connecting to a health monitoring service center 63 via wireless network 61, the Internet 58 and the PSTN 57. The security sensors 51 report detected conditions to the home network server 50. If a detected condition is one for which a warning alarm needs to be sounded, the server 50 communicates with the alarm 58 to cause the alarm to be sounded. The server 50 also sends a communication to the security monitoring service center 62 via wireless network 61, the Internet 58 or the PSTN 57. Similarly, the health sensors 52 communicate information relating to health conditions of the person being monitored to the home network server 50, which then communicates a message to the health monitoring service center 63 via wireless network 61, the Internet 58 or the PSTN 57. Similar communications and monitoring services may be incorporated for the water sensor 53, the power sensor 54 and the light sensor 55.

The home network server 50 executes a home security software program 60 and a home health software program 70. These programs control the processes performed by the server 50 in communicating with the sensors 51-55, the alarm 58, the security panel module 59 the bridge apparatus 10, the security monitoring service center 62 and the health monitoring service center 63. It should be noted that while the devices 51-55, 58 and 59 are shown as communicating wirelessly with the home network server 50, they may instead communicate over wired links.

One of the advantages of the invention is that the security panel module 59 does not require functionality for communicating with the wireless network 61. This is because the bridge apparatus 10 performs this function. As a result, it is unnecessary for the panel module 59 to include such functionality, which reduces costs associated with the panel module 59. The user need only acquire the bridge apparatus 10 if the user desires to have the capability of communicating over the wireless network. Another advantage of having the separate bridge apparatus 10 is that it obviates the need to construct wireless devices having functionality for interfacing with the security panel module 59. Such functionality is generally always included in the wireless devices even if they are never incorporated into the security panel modules. This increases the costs associated with wireless devices intended to be used with the panel modules.

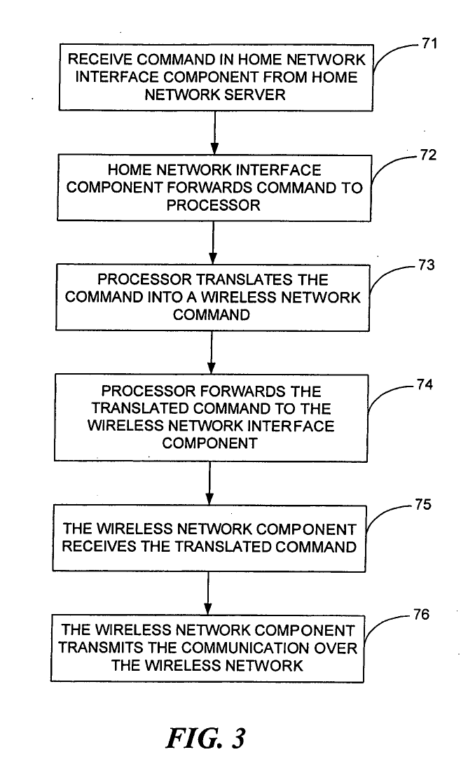

FIG. 3 illustrates a flow chart of the method of the invention in accordance with an exemplary embodiment performed by the bridge apparatus 10. The home network interface component 21 receives a command to send a communication over the wireless network from the home network server, as indicated by block 71. The home network interface component forwards the command to the processor 20, as indicated by block 72. The processor 20 translates the command into a wireless network command, as indicated by block 73. The processor 20 forwards the wireless network command to the wireless network interface component 22, as indicated by block 74. The wireless network interface component 22 receives the command, as indicated by block 75, and wirelessly transmits the wireless network command to the wireless network, as indicated by block 76.

The processor 20 may be any type of computational device that is suitable for performing the functions described above with reference to FIGS. 1-3, including for example, a microprocessor, a microcontroller, an application specific integrated circuit (ASIC), a programmable gate array, etc. The processor 10 may be implemented solely in hardware or in a combination of hardware and software. In the case where the processor 10 is implemented in a combination of hardware and software, the software programs executed by the processor 20 will be stored in memory device 30, or in some other computer-readable medium. The computer-readable medium may be well known memory devices such as, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc.) in packets and in non-packet formats.

It should be noted that the invention has been described with reference to particular embodiments, and that the invention is not limited to the embodiments described herein. Those skilled in the art will understand that many modifications may be made to the embodiments described herein and that all such modifications are within the scope of the invention.

What is claimed is:

1. An apparatus for interfacing a home network to a wireless network comprising:
a home network interface component configured to receive a communication from a home network control center relating to at least one condition detected by at least one sensor within the home network;
a processor configured to receive one or more commands from the home network interface component and to translate the commands into wireless network commands; and
a wireless network interface component configured to receive the translated commands from the processor and to place a call over a wireless network in accordance with the translated commands received from the processor.

2. The apparatus of claim 1, further comprising:
a memory device in communication with the processor for storing one or more software computer programs and data.

3. The apparatus of claim 1, wherein the home network interface component communicates via a wireless link with the home network control center.

4. The apparatus of claim 1, wherein said at least one condition corresponds to a condition relating to security of a home in which the home network is incorporated.

5. The apparatus of claim 1, wherein said at least one condition corresponds to a condition relating to health of a user of the home network.

6. The apparatus of claim 1, further comprising:
a wall outlet plug assembly for enabling the apparatus to be plugged into an electrical wall outlet; and
an Alternating Current (AC)-to-Direct Current (DC) converter for converting an AC signal from the electrical wall outlet into a DC signal that is used to supply power to the apparatus.

7. A method for interfacing a home network to a wireless network comprising:
receiving a command in a home network interface component from a home network control center, the command being associated with one or more conditions detected by one or more sensors of a home network;
processing the command in a processor that is in communication with the home network interface component to translate the command into a wireless network command;
forwarding the wireless network command from the processor to a wireless network interface component;
receiving the wireless network command in the wireless network interface component; and
transmitting the wireless network command from the wireless network interface component to a wireless network.

8. The method of claim 7, wherein the home network interface component communicates via a wireless link with the home network control center.

9. The method of claim 7, wherein said at least one condition corresponds to a condition relating to security of a home in which the home network is incorporated.

10. The method of claim 7, wherein said at least one condition corresponds to a condition relating to health of a user of the home network.

11. A computer program for interfacing a home network to a wireless network, the program being embodied on a computer-readable medium, the program comprising instructions for execution by a computer, the program comprising:
instructions for receiving a command in a home network interface component from a home network control center, the command being associated with one or more conditions detected by one or more sensors of a home network;
instructions for processing the command in a processor that is in communication with the home network interface component to translate the command into a wireless network command;
instructions for forwarding the wireless network command from the processor to a wireless network interface component;
instructions for receiving the wireless network command in the wireless network interface component; and
instructions for transmitting the wireless network command from the wireless network interface component to a wireless network.

12. The computer program of claim 11, wherein the home network interface component communicates via a wireless link with the home network control center.

13. The computer program of claim 11, wherein said at least one condition corresponds to a condition relating to security of a home in which the home network is incorporated.

14. The computer program of claim 11, wherein said at least one condition corresponds to a condition relating to health of a user of the home network.
